(19) United States
(12) Patent Application Publication
(10) Pub. No.: US 2011/0167919 A1
(43) Pub. Date: Jul. 14, 2011

(54) Vacuum measuring device with interchangeable sensors

(75) Inventors: Heinz Plöchinger, Freinberg (AT); Georg Sickinger, Ortenburg (DE)

(73) Assignee: PLOECHINGER PATENT, Freinberg (AT)

(21) Appl. No.: 13/005,502

(22) Filed: Jan. 12, 2011

Related U.S. Application Data
(60) Provisional application No. 61/294,510, filed on Jan. 13, 2010.

(51) Int. Cl. G01L 9/00; G06K 19/077; G06K 19/00; G06K 7/01

(52) U.S. Cl. 73/753; 73/700; 235/492; 235/487; 235/375; 374/E07.004

(57) ABSTRACT

An interoperable vacuum measuring device is presented, which automatically adjusts to one of two or more vacuum sensors having different electrical characteristics. The interoperable vacuum measuring device in a first step detects which type of vacuum sensor it is connected to. In a second step it controls and evaluates the vacuum sensor, using control parameters determined in response to the detection of the first step.

Detection of a vacuum sensor type is achieved by measuring the electrical resistance between any two pins of a vacuum sensor's connector and comparing the measured resistance values with stored resistance values of known vacuum sensors.

Further, a vacuum measuring device is presented, which automatically identifies a vacuum sensor, and associates a vacuum pressure measurement with a vacuum sensor. The identification of a vacuum sensor is facilitated by an identification disk, which is placed onto and operatively connected to the male terminals of a vacuum sensor's connector.

### CLAIM FOR PRIORITY

This application claims priority of U.S. provisional patent application No. 61/294,510, filed Jan. 13, 2010, which is hereby incorporated by reference.

### TECHNICAL FIELD

The present invention generally relates to vacuum measuring devices, and more particularly, to vacuum measuring devices with interchangeable vacuum sensors.

### BACKGROUND OF THE INVENTION

Vacuum measuring systems are widely used and typically comprise a vacuum sensor and a vacuum measuring device. The vacuum measuring device controls and reads the vacuum sensor. The vacuum sensor is typically permanently attached to a vacuum container using an air-sealed interface. The vacuum measuring device may be portable and carried between several vacuum containers, especially if continuous monitoring of the vacuum container is not required. The vacuum sensor is typically connected to the vacuum measuring device using a plug-in connector. Commonly used vacuum sensors are thermocouple gauge tubes.

While several different vacuum sensor manufacturers utilize the same electrical connector geometry, their vacuum sensors differ in their electrical characteristics and connector pinout. Therefore, vacuum sensors and vacuum measuring devices have to be matched, so that the correct vacuum measuring device is used with each vacuum sensor. This requires a user of vacuum measuring equipment to purchase matching vacuum measuring devices for each vacuum sensor. It also creates a risk of accidentally connecting the wrong vacuum measuring device to a vacuum sensor, which may lead to incorrect measurements, or may even cause damage to the vacuum sensor or the vacuum measuring device.

Vacuum measuring devices are known, which support two different vacuum sensor models by providing sockets for two different connectors, one for each sensor model. Those measuring devices however require an operator to identify the sensor model to be connected and select the correct socket for the sensor, still leaving the opportunity for operator error and accidental wrong connections.

Where vacuum pressure in two or more containers is measured using the same vacuum measuring device it is desirable to automatically detect, which vacuum container, respectively vacuum sensor, the measuring device is connected to. However, current vacuum sensors provide no means for identifying a particular sensor, so that an operator has to rely on a separate process to identify the vacuum container, to which a vacuum sensor is connected. This allows for potential errors, in which a vacuum pressure measurement is incorrectly associated with the wrong vacuum container.

Therefore, in light of the problems associated with existing approaches, there is a need for improved vacuum sensing devices, which are interoperable with vacuum sensors from different manufacturers, those sensors having different electrical characteristics and pinouts. It is further desirable to automatically identify a vacuum sensor, in order to associate a vacuum pressure measurement with a vacuum container.

### SUMMARY OF THE INVENTION

In one aspect of the present invention an interoperable vacuum measuring device is presented, which automatically adjusts to one of two or more vacuum sensors having different electrical characteristics. The interoperable vacuum measuring device in a first step detects, which type of vacuum sensor it is connected to. In a second step it controls and evaluates the vacuum sensor, using control parameters determined in response to the detection of the first step.

A vacuum sensor may be identified by measuring the electrical resistances between its connector pins. A particular vacuum sensor type and manufacturer may then be determined through a lookup table, which correlates the measured resistance values with a particular vacuum sensor type and manufacturer. The lookup table may further comprise information about the sensor's electrical characteristics, e.g. its supply voltage, heating current, pinout, and the correlation of output voltage and vacuum pressure (the vacuum sensor characteristic line). The lookup table may comprise data for two or more vacuum sensors. The values contained in the lookup table may be empirically gathered data, which may be determined by analyzing and measuring an exemplary sensor.

While vacuum sensors of different manufacturers may use a common connector, their pinout may be different. Different pinouts cause the resistance between two pins in the connector to change, thereby supporting the discrimination of sensors in the lookup table.

In a further aspect of the present invention a vacuum measuring device is presented, which automatically identifies a vacuum sensor, and associates a vacuum pressure measurement with a vacuum sensor. The identification of a vacuum sensor is facilitated by an identification disk, which is placed onto and operatively connected to the male terminals of a vacuum sensor's connector. The identification disk has a body which is favorably shaped like the connector. Holes are arranged in the body to allow the pins of the vacuum sensor to protrude the identification disk. The disk is thin enough to fit between the sensor's connector and the measuring device's socket without affecting the electrical connection between the sensor and the measuring device. Contacts are located in at least two of the disk's holes, electrically connecting the protruding terminals with at least one identifiable electric or electronic component inside the identification disk. The identifiable electric or electronic component inside the identification disk may e.g. be a resistor having an identifiable value or a non-volatile memory device comprising an identification number. The at least one electric or electronic component may also be a binary-coded conductor arrangement which may e.g. be coded by lasers. It may further be a set of switches, ROM, PROM, EPROM or FLASH memories or other electronic storage media.

When a vacuum measuring device is attached to a vacuum sensor having an identification disk, a microcontroller within the vacuum measuring device becomes operatively connected to the identifiable electric or electronic component in the identification disk. The microcontroller identifies the identifiable electric or electronic component, e.g. by determining the resistance value of an identifiable resistor or reading an identification number out of an identifiable electronic memory. The identification of a particular vacuum sensor may be used to associate vacuum pressure measurements with a particular vacuum sensor, and thus a particular vacuum container. The microcontroller in the measuring device may comprise an electronic memory and store vacuum measurement values, time stamps, operator identification and other data in association with a vacuum sensor identification. The electronic record may also be transferred to a computer system, considerably simplifying task including monitoring of equipment, quality assurance and documentation.

A writable electronic memory, e.g. an EPROM element, can be used as the identifiable electronic component, so that the time and value of the last vacuum pressure measurement can be stored inside the identification disk. This allows an immediate comparison between the last and the current vacuum pressure value. A rise in vacuum pressure, for example, due to leaks, can thus be recognized immediately without need to refer to any data stored outside the vacuum sensor and its identification disk.

In a further embodiment, the measuring device or the code disk is equipped with a radio module and at predetermined time intervals or continuously can wirelessly transmit the measured values together with the identification data to a central unit or wirelessly read the sensor identification, e.g., via an RFID (radio frequency identification) tag present in the disk.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is an illustration showing multiple vacuum sensors, an identification disk, and a schematic vacuum measuring device.

FIG. 2 shows an exemplary circuit diagram of an interoperable vacuum sensing device.

FIG. 3 shows an exemplary identification disk for use with vacuum sensors.

### DETAILED DESCRIPTION

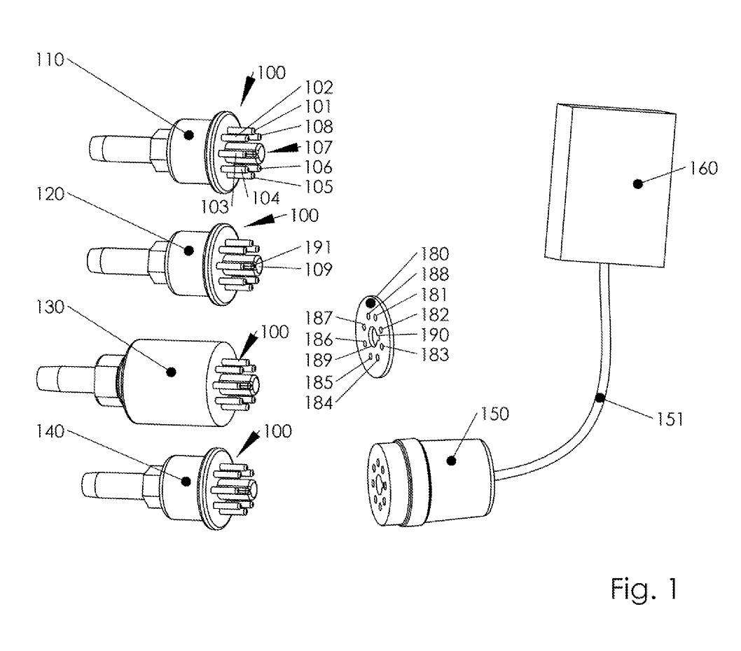

Referring to FIG. 1, an exemplary embodiment in which aspects of the present invention are advantageously practiced is illustrated generally. Several vacuum sensors (110, 120, 130, 140) are shown, which utilize a common connector layout. An identification disk 180 is provided, which can be placed between the male connector 100 of vacuum sensor 110, 120, 130 or 140 and socket 150 of a vacuum measuring device 160. Socket 150 is connected to a pig-tail 151, which is terminated in vacuum measuring device 160. Vacuum measuring device 160 is operatively connected to one of the vacuum sensors 110, 120, 130 or 140 trough connector 100, when plugged into socket 150. Vacuum measuring device 160 may comprise a display for displaying the vacuum pressure. Vacuum measuring device 160 may also comprises an output (not shown), which is configured to provide a vacuum pressure signal. The output may be any form of communicable electrical signal, e.g. a variable voltage, variable current, pulse width modulated signal or a serial or parallel digital communication signal.

Identification disk 180 mimics the geometry of and can be placed onto connector 100. Identification disk 180 comprises holes 181-188, through which the male terminals 101-108 of connector 100 protrude. A center hole 189 is provided, which allows the center pin 109 of connector 100 to protrude. Center hole 189 also provided rotational alignment between identification disk 180 and connector 100, by engaging recess 190 of center hole 189 with guide pin 191 of center pin 109.

Identification disk 180 may be placed onto connector 100 of vacuum sensor 110, 120, 130 or 140. Identification disk 180 is held in place by interference fit between male terminals 101-108 and holes 181-188, center pin 109 and center hole 189, or both. Identification disk 180 is thin, so that terminals 101-108 protrude identification disk 180 far enough to firmly engage the female pins of socket 150, when connector 100 is plugged into socket 150.

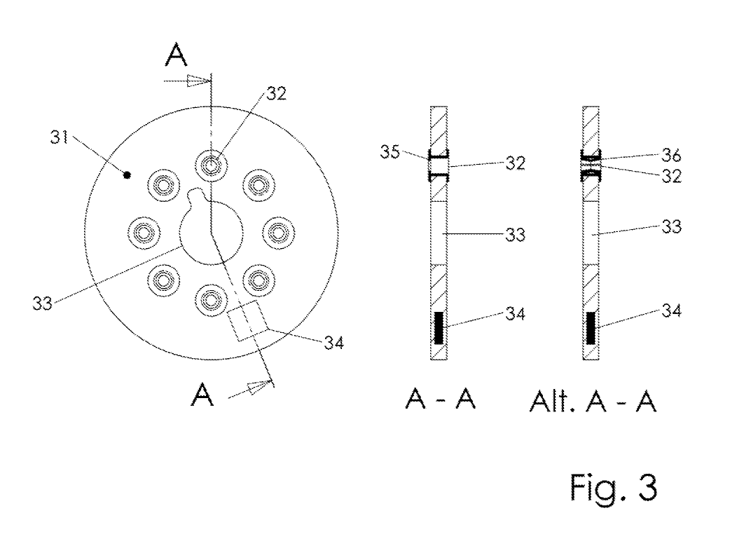

FIG. 3 shows a plan view of and a section through an identification disk 31. Holes 32 are located such that the male terminals of a vacuum sensor can protrude identification disk 31 and enclose them in a resilient manner. A central recess 33 is provided for guide pins of the connector with guide key.

Identification disk 31 may be a multilayer circuit boards with corresponding recesses and contain an integrated storage element or identification element 34. Identification disk 31 is preferably made of FR4, but any other material known in the art of manufacturing circuit boards may be used. Identification disk 31 is preferably less than 3 mm thick. Identification element 34 may e.g. be a resistor, EPROM, or other identifiable component connected by conductor paths to contacts 35, 36 in holes 32. A connected measuring device has access to the identification element or storage element in the identification disk through the corresponding contacts 35, 36 in holes 32. Contacts 35 is an exemplary contact using form fit to establish an electrical connection with the protruding male terminal in hole 32.

An exemplary method of using a vacuum sensor with attached identification disk comprises the following steps:
Placing an identification disk 180 onto the connector 100 of a vacuum sensor (110, 120, 130, 140). This step is performed only once, whereas some or all of the following steps are performed each time a vacuum measurement is taken.
Attaching the socket 150 of a vacuum measuring device 160 to a vacuum sensor (110, 120, 130, 140).
Switching on vacuum measuring device 160.
Identifying the vacuum sensor (110, 120, 130, 140).
Reading the sensor number of vacuum sensor (110, 120, 130, 140).
Reading of the last measurement date stored in the coding disk 180.
Reading of the last measured value stored in the coding disk 180.
Measuring vacuum pressure sensed by the vacuum sensor (110, 120, 130, 140).
Storing the current measured value in the identification disc 180.
Storing the current measurement date in the identification disc 180.
Optionally, transmitting the measured data by radio (e.g., ZigBee, WLAN, RFID)
Optionally battery operated push-on module with radio, which, e.g., transmits one measured value daily.
Switching off vacuum measuring device 160.
Removing the socket adapter 150 from vacuum sensor (110, 120, 130, 140).

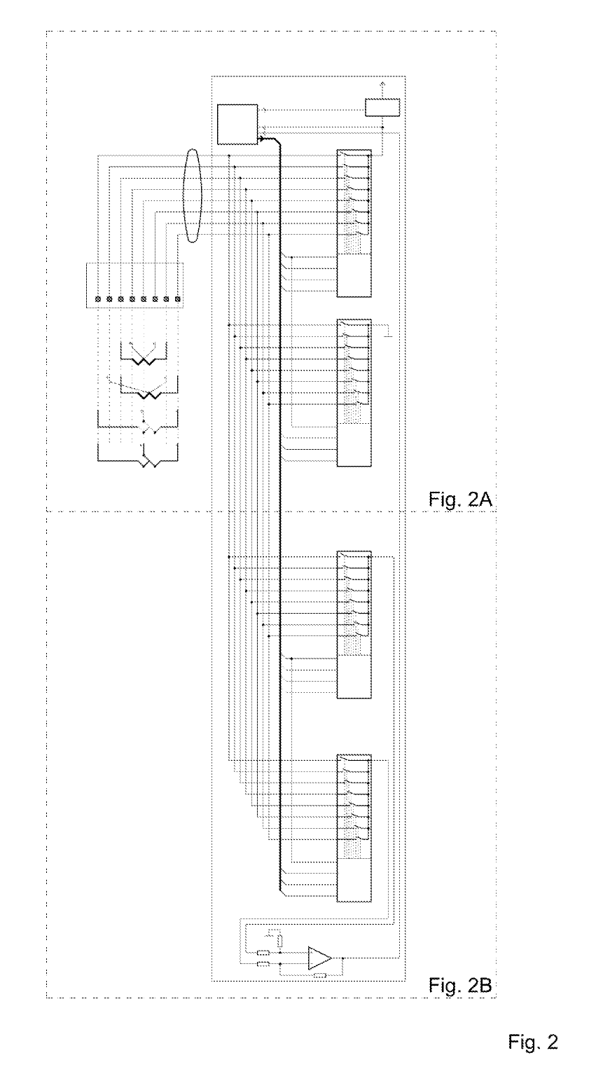

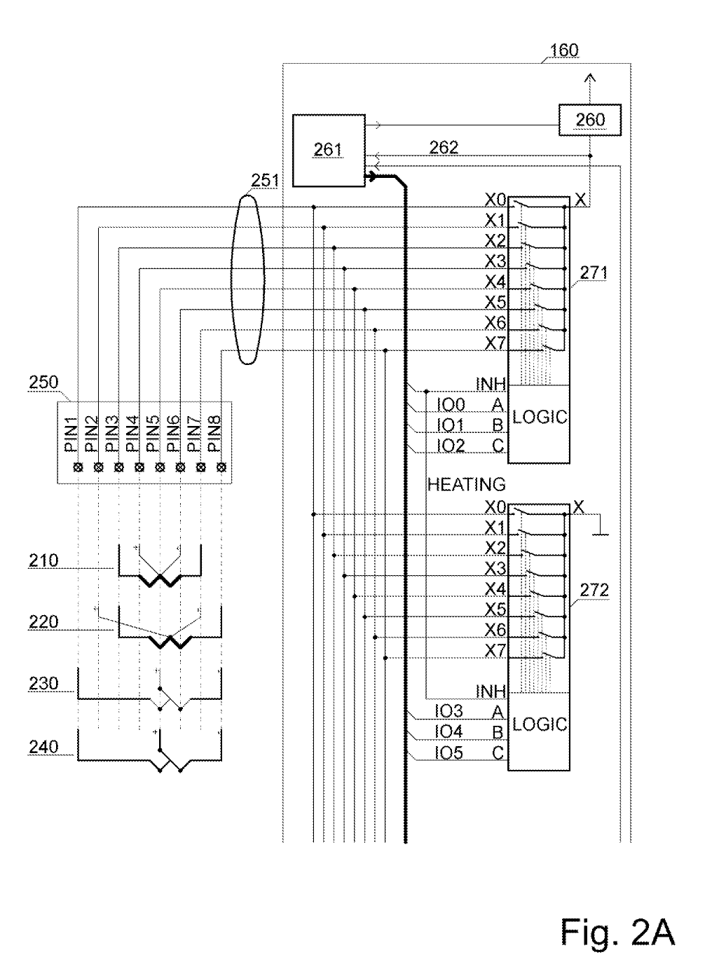

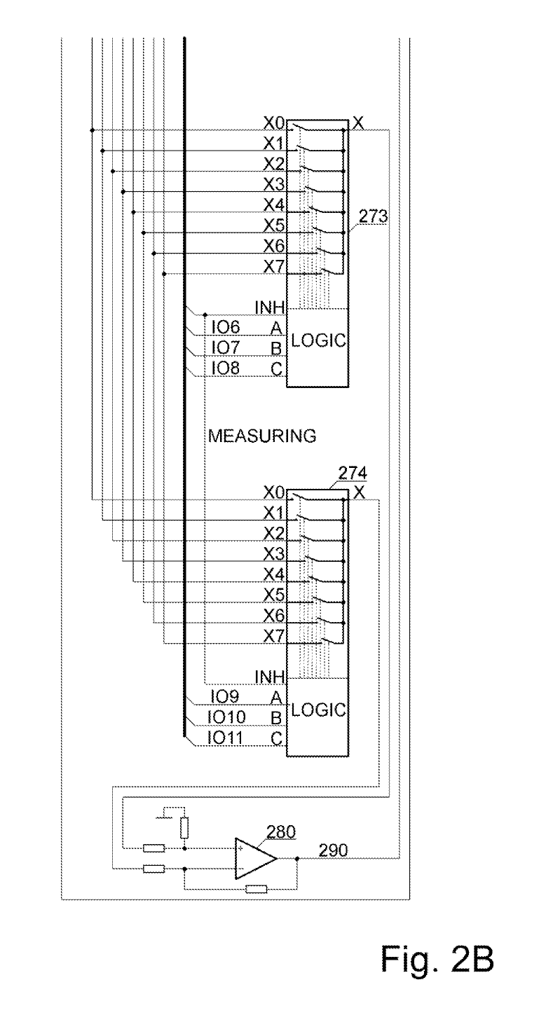

Referring now to FIG. 2 an exemplary electric circuit diagram according to an aspect of the present invention is illustrated generally. Four electrically distinct vacuum sensors 210, 220, 230 and 240 are shown. Vacuum sensors 210, 220 and 230 utilize a different connector pinout. For example, vacuum sensor 230 is powered through pins 1 and 8, while pin 5 serves as a signal pin. In contrast, vacuum sensor 210 is powered trough pins 3 and 7, while pins 4 serve as a signal pin, and pin 6 as a ground reference. Vacuum Sensors 230 and 240 have the same pinout but differ in the resistance values of the internal connections. Vacuum sensors 210, 220, 230 and 240 may be thermocouple gauge tubes, and exhibit different electrical characteristics.

Each of the sensors 210, 220, 230, or 240 can be connected to the socket 250. Socket 250 comprises 8 socket pins, labeled PIN1 through PIN8. The pins of the socket 250 are connected through cable 251 to an electronic circuit in the vacuum measuring device 160. Vacuum measuring device 160 comprises four multiplexers 271, 272, 273 and 274. Each multiplexer selectively connects an input X with one output X0 through X7. Which output X0 through X7 input X is connected to is controlled by control inputs A, B, C, and INH. Control inputs A, B, C, and INH are operatively connected to a microcontroller 261. Microcontroller 261 comprises an analog-digital (A/D) converter and electronic memory. Microcontroller 261 is operatively connected to an adjustable current or voltage source 260. Vacuum measuring device 160 further comprises an amplifier arrangement 280, a display unit (not shown), an output unit (not shown) and an input unit (not shown). Microcontroller 261 can establish various connection configurations, in which each PIN1 through PIN8 of socket 250 can be connected to either adjustable current or voltage source 260, to ground, or to amplifier arrangement 280. Each connection configuration is a unique combination of connecting the adjustable current or voltage source 260 and ground to the more socket pins PIN1 through PIN8 of socket 250. Multiplexer 272 establishes an electrical return path for current through vacuum sensors 210, 220, 230 or 240. While this return path is shown to be ground, it should be understood that a different return potential may be used.

Each PIN1-8 of socket 250 is wired in parallel to each multiplexer 271, 272, 273 and 274. Each multiplexer 271, 272, 273, and 274 is operatively connected to all 8 socket pins of socket 250.

Multiplexer 271 is configured to selectively connect adjustable current or voltage source 260 to any of pin 1-8 of socket 250. Adjustable current or voltage source 260 may be a voltage controlled current source, which is operatively connected to and controlled by microcontroller 261. It may more specifically be a current source suitable to power a thermocouple gauge tube. Similarly, multiplexer 272 can selectively connect a current sink or ground to any of pins 1 through 8 of socket 250. By selecting the appropriate outputs of multiplexers 271 and 272 any vacuum sensor 210, 220, 230 or 240 can be powered by adjustable current or voltage source 260, irrespective of the pinout of the vacuum sensor. Multiplexer 271 operates as a supply pin selector, which operatively connects current or voltage source 260 with any one of PIN1 through PIN8 of socket 250. Multiplexer 272 operates as a return pin selector, establishing a return path for current from vacuum sensor 210, 220, 230 or 240 through any one of PIN1 through PIN8. Multiplexers 273 and 274 operate as signal pin selectors, connecting any one of PIN1 through PIN8 to amplifier 280. While multiplexers 271, 272, 273, and 274 are shown as four integrated circuits they may also be combined into fewer than four components, or separated into more than four components. Multiplexers 271, 272, 273, and 274 may also be replaced by any other electronically controlled switching device known in the art.

In an exemplary embodiment vacuum measuring device 160 is configured to automatically detect, which type of vacuum sensor 210, 220, 230 or 240 is connected to socket 250. Automatic detection is achieved while in a detection mode by sequentially connecting adjustable current or voltage source 260 and ground 263 to different pins of socket 250 through multiplexers 271 and 272. Adjustable current or voltage source 260 is controlled to establish a predetermined evaluation current, e.g. 1 mA. The output voltage of output 262 of adjustable current source 260 is read by an A/D converter input of microcontroller 261. Microcontroller 261 calculates the electrical resistance between output 262 and ground 263 by dividing output voltage 262 by the selected adjustable evaluation current value. The calculated electrical resistance between one or more pairs of pins of a vacuum sensor is indicative of its type. An electronic memory within microcontroller 261 comprises a table of predetermined resistance values with associated multiplexer settings for multiplexers 271 and 272.

The following example describes the automatic detection of a vacuum sensor 210 (type D): First, microcontroller 261 configures multiplexer 271 to connect adjustable current source 260 to pin 3 of socket 250. Microcontroller 261 configures multiplexer 272 to connect ground 263 to pin 7 of socket 250. Next, microcontroller 261 configures adjustable current source 260 to a predetermined current. The predetermined evaluation current flows from adjustable current source 260 through multiplexer 271 and pin 3 of socket 250 into the vacuum sensor 210. It returns through pin 7 of socket 250 and multiplexer 272 to ground 263. Microcontroller 261 calculates the resistance between adjustable current source 260 and ground 263 by measuring the voltage of output 262 and dividing it by the predetermined evaluation current. In a further step microcontroller 261 compares the calculated electrical resistance with a stored value of typical resistances for a vacuum sensor 210. If the calculated resistance falls within the range that is typical for type D vacuum sensors microcontroller 261 determines, that a type D vacuum sensor is connected to socket 250. The calculated resistance equals the internal resistance of vacuum sensor 210 between pin 3 and pin 7 plus contact resistances, wiring resistance and resistance of multiplexers 271 and 272. Microcontroller 261 is programmed to consider for the total resistance between current source 260 and ground 263.

In some instances measuring the resistance between any two pins of a vacuum sensor may not be sufficient to identify the type of vacuum sensor. Two vacuum sensors with identical pinout and similar internal resistances may be distinguished by evaluating the polarity of thermoelectric voltage 290.

After a type of vacuum sensor has been identified, microcontroller 261 switches into an operating mode and controls multiplexers 273 and 274 to connect amplification circuit 280 to the measuring element within vacuum sensor 210, 220, 230 or 240. The correct settings for multiplexer 273 and 274 may be stored in the electronic memory of microcontroller 261. Generally, the pinout information for various vacuum sensors may be associated with empirically collected internal resistance values between selected pins for each vacuum sensor. If, per the example above, a type D vacuum sensor has been detected microcontroller 261 controls multiplexer 273 to connect its input X3 (pin 4) to its output X. Microcontroller 261 controls multiplexer 274 to connect its input X5 (pin 6) to its output X. Thereby the sensor output on pins 4 and 6 of vacuum sensor 210 are operatively connected to amplification circuit 280 in vacuum measuring device 160. Amplification circuit 280 feeds thermocouple voltage output 290.

For embodiments with limited flexibility multiplexers 273 and 274 may be omitted, limiting the vacuum measuring device 160 to be operative only with vacuum sensors that use common pinout of their measuring outputs. Alternatively, multiplexers 273 and 274 may be replaced by a limited number of switches, limiting the vacuum measuring device 160 to be operative only with vacuum sensors that use a pinout adequate to the possible switch positions.

Microcontroller 261 may be programmed to automatically identify a vacuum sensor type that is connected to socket 250 by executing the following steps:
1. Controlling adjustable current source 260 to a low evaluation current (e.g. 0.1-3 mA). The low evaluation current is selected such, that any vacuum sensor attached to socket 250 will not be damaged, even if the evaluation current is applied in a manner inconsistent with the intended use of the vacuum sensor. This may e.g. include current flow through the thermoelectric sensing connections of a thermocouple vacuum gauge.
2. Measuring the output voltage of adjustable current source 260 while multiplexers 271 and 272 are inactive. This step may optionally be omitted, since the voltage measured in this step may equal the supply voltage of the adjustable current source and therefore be known.
3. Selecting an output X0 . . . X7 of multiplexer 271 by controlling its control lines “IO_O,” “IO_{—}1” and “IO_{—}2”.
4. Selecting an output X0 . . . X7 of multiplexer 272 by controlling its control lines “IO_{—}3,” “IO_{—}4” and “IO_{—}5”. The selected output X0 . . . X7 of multiplexer 272 should be different than the selected output X0 . . . X7 of multiplexer 271 to avoid causing a short of the adjustable current source to ground.
5. Activating multiplexers 271 and 272 by applying a “heating” activation signal. The “heating” signal may be applied to an inhibit entry of the multiplexer.
6. Measuring the output voltage of adjustable current source 260.
7. Calculating the current flow through the selected pins of the vacuum sensor. The current flow can be calculated as a function of the evaluation current selected in step 1 and the output voltage measured in step 6. If the output voltage measured in step 6 is essentially the same as the output voltage measured in step 2 no current flows through the vacuum sensor attached to socket 250.
8. Repeating steps 4 through 7 for all possible multiplexer settings.
9. Comparing the current flows calculated in step 7 for given multiplexer settings to a table of known current flows for the same multiplexer settings. The table of known current flows may have been empirically determined by measuring various types of vacuum sensors.
10. Determining the type of vacuum sensor connected to socket 250 in response to the comparison of step 9.
11. Selecting an output X0 . . . X7 of multiplexer 271 and an output X0 . . . X7 of multiplexer 272 in response to the type determination of the attached vacuum sensor in step 10. The selection is made such that the vacuum sensor is operated according to the intended use for a sensor of the determined type as provided by its manufacturer (stored in a table).
12. Controlling adjustable current source 260 to an operating current. The appropriate operating current may be selected from a lookup table. The lookup table comprises appropriate operating currents for each vacuum sensor type determined in step 10.
13. Selecting an input X0 . . . X7 of multiplexer 273 and an input X0 . . . X7 of multiplexer 274 by controlling their respective control inputs “IO_{—}6 through IO_{—}11”. The settings for multiplexers 273 and 274 may be selected from the lookup table. The measuring output of vacuum sensor is operatively connected through multiplexers 273 and 274 to an amplification circuit 280.
12. Measuring the vacuum pressure surrounding the vacuum sensor. Vacuum pressure may be measured by alternating between a heating and a measuring cycle. During a heating cycle activating multiplexers 271 and 272 are activated by applying a heating signal applied to the multiplexers' inhibit input. During a measuring cycle multiplexers 273 and 274 are activated by applying a measuring signal to the multiplexers' inhibit input.

In variation to the exemplary method described above step 8 may be slightly modified. Instead of analyzing all possible settings of multiplexers 271 and 272 steps 4 through 7 may be repeated following a sequence of predetermined multiplexer settings until the vacuum sensor attached to socket 250 has been unambiguously identified.

While the invention has been described with reference to vacuum sensors and specifically to thermocouple gauge tubes it may be beneficially applied to many other sensors, which need not be based on thermocouple technology.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A vacuum measuring device configured to operate with interchangeable vacuum sensors, the vacuum measuring device comprising:
a socket, the socket comprising three or more socket pins for connecting a vacuum sensor;
an adjustable current or voltage source;
a first multiplexer operatively connected to the adjustable current or voltage source and configured to selectively connect the adjustable current or voltage source to any one of the three or more socket pins; and
a second multiplexer operatively connected to an electrical return path and configured to selectively connect the electrical return path to any one of the three or more socket pins.

2. The vacuum measuring device as in claim 1, further comprising a microcontroller which is operatively connected to the adjustable current or voltage source, the first multiplexer, and the second multiplexer,
wherein the adjustable current or voltage source is controlled by the microcontroller to selectively operate in a detection mode and an operating mode.

3. The vacuum measuring device as in claim 2, wherein an output voltage of the adjustable current or voltage source is measured and processed in the microcontroller.

4. The vacuum measuring device as in claim 1 further comprising a microcontroller,
wherein the first multiplexer and the second multiplexer are controlled by the microcontroller to sequentially establish two or more connection configurations,
wherein each of the two or more connection configurations is a unique combination of connecting the adjustable current or voltage source and the electrical return path to the three or more socket pins.

5. The vacuum measuring device as in claim 4, further comprising a vacuum sensor connected to the socket,
wherein the microcontroller in a detection mode calculates a resistance between the adjustable current or voltage source and the electrical return path for each of the two or more connection configurations.

6. The vacuum measuring device as in claim 5, wherein the microcontroller compares the resistance for each of the two or more connection configurations with resistance values stored in memory for known vacuum sensors, and thereby determines a type of the vacuum sensor connected to the socket.

7. The vacuum measuring device as in claim 5, wherein the vacuum sensor is a thermocouple gauge tube.

8. The vacuum measuring device as in claim 1, wherein the return path is ground.

9. A vacuum measuring device interoperable with a plurality of vacuum sensors having distinct electrical characteristics, wherein
the vacuum measuring device automatically detects electrical characteristics of an attached vacuum sensor and
thereafter selects one or more operating parameters in response to the detected electrical characteristics of the attached vacuum sensor.

10. The vacuum measuring device as in claim 9, wherein the operating parameters are selected from the group consisting of a vacuum sensor supply voltage, a vacuum sensor heating current or voltage, a vacuum sensor characteristic line associating voltage measurements with pressure value, and a vacuum sensor pinout.

11. The vacuum measuring device as in claim 9, wherein the attached vacuum sensor has a connector with three or more connector pins, and the electrical characteristics are electrical resistances between any two connector pins.

12. The vacuum measuring device as in claim 9, wherein the one or more operating parameters are selected from a table stored in an electronic memory in the measuring device.

13. A method for operating a vacuum measuring device having a vacuum sensor connected thereto comprising the steps of:
1. identifying the vacuum sensor; and
2. selecting vacuum sensor operating parameters in response to step 1.

14. The method as in claim 13, wherein the vacuum sensor has a connector with three or more connector pins and wherein the step of identifying the vacuum sensor comprises the steps of:
1. controlling an adjustable current source within the vacuum measuring device to an evaluation current level;
2. applying the evaluation current to selected vacuum sensor connector pins;
3. determining the electrical resistance between the selected vacuum sensor connector pins; and
4. repeating steps 2 and 3 for different vacuum sensor connector pins.

15. The method as in claim 14, wherein the step of selecting vacuum sensor operating parameters comprises the steps of:
1. comparing the electrical resistance between selected vacuum sensor pins with values stored in a look-up table;
2. selecting one entry in the look-up table based on step 1 above;
3. reading operating parameters of the vacuum sensor associated with the entry in the look-up table selected in step 2; and
4. applying operating parameters read in step 3 to the vacuum sensor.

16. An identification disk adapted to fit between a connector and a socket of a vacuum sensor and a vacuum measuring device, comprising:
holes arranged for male terminals of the connector to protrude and engage female terminals of the socket; and
an identifiable component adapted to be identified by the vacuum measuring device.

17. The identification disk as in claim 16, wherein the identifiable component is an electric or electronic component which becomes operatively connected to two or more of the male terminals of the connector when the identification disk is placed onto the connector.

18. The identification disk as in claim 17, further comprising contact springs located in at least two of the holes, electrically connecting the male terminals with the identifiable electric or electronic component.

19. The identification disk as in claim 17, wherein the electric or electronic component is a resistor having an identifiable value, a non-volatile memory device comprising an identification number, a binary-coded conductor arrangement, or a set of switches.

20. The identification disk as in claim 17, wherein the electric or electronic component is a ROM, PROM, EPROM or FLASH memory component.

21. The identification disk as in claim 16, wherein the disk is made of printed circuit board material and has a thickness of less than 3 mm.

22. The identification disk as in claim 20, wherein the memory component contains information relating to a type or operating parameters of the vacuum sensor.

23. A method for identifying a vacuum sensor having a male connector, comprising the steps of:
1. placing an identification disk comprising an identifiable component onto a the male connector of the vacuum sensor;
2. connecting a vacuum measuring device to the vacuum sensor; and
3. identifying the identifiable component of the identification disk.

24. The method as in claim 23, further comprising the step of associating vacuum measurements with at least one of the identification disk, the identifiable component, or the vacuum sensor.

25. The method as in claim 23 further comprising the step of writing data associated with a vacuum measurement into an electronic memory of the identifiable component.
